(19) United States
(12) Patent Application Publication
(10) Pub. No.: US 2022/0120597 A1
(43) Pub. Date: Apr. 21, 2022

(54) THERMAL FLOW RATE SENSOR

(71) Applicant: DENSO CORPORATION, Kariya-city (JP)

(72) Inventors: Hajime MASHITA, Kariya-city (JP); Yasushi KOUNO, Kariya-city (JP); Jyunzou YAMAGUCHI, Kariya-city (JP)

(21) Appl. No.: 17/565,049

(22) Filed: Dec. 29, 2021

Related U.S. Application Data
(63) Continuation of application No. PCT/JP2020/026553, filed on Jul. 7, 2020.

(30) Foreign Application Priority Data
Jul. 8, 2019 (JP) 2019-127165

(51) Int. Cl. G01F 1/692

(52) U.S. Cl. CPC G01F 1/692

(57) ABSTRACT

A thin film is formed on a substrate on which an opening having two opposite sides are formed, and forms a membrane. The thin film has an upstream temperature sensor and a downstream temperature sensor on both sides of a heater. A heat conductive member covers the two sides and is arranged on both sides of the heater, the upstream temperature sensor, and the downstream temperature sensor so as to promote heat conduction from the heater to the substrate. When an end of the opening on the membrane side is defined as an upper end and an end on the side away from the membrane is defined as a lower end, the heat conductive member covers from the upper end to the lower end of the opening in a normal direction of the membrane.

### CROSS REFERENCE TO RELATED APPLICATION

This application is a continuation application of International Patent Application No. PCT/JP2020/026553 filed on Jul. 7, 2020, which designated the U.S. and based on and claims the benefits of priority of Japanese Patent Application No. 2019-127165 filed on Jul. 8, 2019. The entire disclosure of all of the above applications is incorporated herein by reference.

### TECHNICAL FIELD

The present disclosure relates to a thermal flow rate sensor that detects a flow rate of a fluid.

### BACKGROUND

A thermal flow rate sensor is equipped with a thin film membrane on a substrate, in other words, a diaphragm. In the thermal flow rate sensor, a heater is arranged in the membrane, and temperature sensors are located on an upstream side and a downstream side of a fluid flow through the heater, respectively.

### SUMMARY

An object of the present disclosure is to provide a thermal flow rate sensor capable of suppressing variation in the amount of heat conduction between upstream and downstream of a fluid flow through the heater.

A thermal flow rate sensor according to one aspect of the present disclosure includes a substrate on which an opening having two opposite sides is formed, a thin film formed on the substrate, and a heat conductive member. The thin film forms a membrane, and between the two opposite sides, the membrane has a heater, an upstream temperature sensor located on one side of the heater, and a downstream temperature sensor located on the opposite side of the upstream temperature sensor across the heater. The heat conductive member promotes heat conduction from the heater to the substrate. In such a configuration, when an end of the opening on the membrane side is defined as an upper end and an end on the side away from the membrane is defined as a lower end, the heat conductive member covers from the upper end to the lower end of the opening in a normal direction of the membrane.

### BRIEF DESCRIPTION OF DRAWINGS

FIG. 1 is a top layout view of a thermal flow rate sensor according to a first embodiment;

FIG. 2 is a cross-sectional view taken along line II-II in FIG. 1;

FIG. 3 is a circuit diagram of a Wheatstone bridge circuit with resistance temperature detectors constituting an upstream temperature sensor and a downstream temperature sensor;

FIG. 4 is a cross-sectional view showing a case where a heat conductive member is formed only on a part of a side surface of an opening;

FIG. 5 is a top layout view when the sides formed by the side surface of the opening are not linear;

FIG. 6 is a cross-sectional view of a thermal flow rate sensor described in a modified example of the first embodiment;

FIG. 7 is a top layout view of the thermal flow rate sensor according to a second embodiment;

FIG. 8 is a top layout view of a thermal flow rate sensor described in a modified example of the second embodiment;

FIG. 9 is a top layout view of the thermal flow rate sensor according to a third embodiment;

FIG. 10 is a top layout view of the thermal flow rate sensor according to a fourth embodiment;

FIG. 11 is a top layout view of the thermal flow rate sensor according to a fifth embodiment;

FIG. 12 is a cross-sectional view of a thermal flow rate sensor described in another embodiment; and

FIG. 13 is a top layout view of a thermal flow rate sensor described in another embodiment.

### DETAILED DESCRIPTION

In an assumable example, a thermal flow rate sensor is equipped with a thin film membrane on a substrate, in other words, a diaphragm. In the thermal flow rate sensor, a heater is arranged in the membrane, and temperature sensors are located on an upstream side and a downstream side of a fluid flow through the heater, respectively. In such a configuration, when the heater is heated to a constant temperature, a temperature difference occurs between the upstream and downstream of the heater according to the flow rate of the fluid, and a resistance value of a temperature measuring resistance constituting both temperature sensors is different. Based on this configuration, the thermal flow rate sensor detects the flow rate of the fluid using a signal representing the difference in resistance values as a detection signal.

In such a thermal flow rate sensor, there are variations in the workmanship of the membrane, that is, variations depending on a positional deviation between a formation position of an opening formed in the substrate for forming the membrane and a formation position of the heater or the temperature sensor.

Therefore, a heat conductive member having high thermal conductivity is provided in an edge region of the membrane in each of the upstream and downstream of the fluid flow through the heater and both temperature sensors. By forming the heat conductive member at the same time as the heater and the temperature sensors, it is possible to obtain a highly accurate relative position and suppress the influence of variations in the workmanship of the membrane.

However, it may not be possible to sufficiently suppress the influence of variations in the workmanship of the membrane simply by providing the heat conductive member in the edge region of the membrane.

For example, the opening of the substrate is formed by etching from a surface of the substrate on an opposite side of the membrane, but a side surface of the opening is inclined to some extent. When an end of the opening formed on the substrate on the membrane side is referred to as an upper end and an end on the side away from the membrane is referred to as a lower end, a size of the opening becomes taper from the lower end side to the upper end side. Therefore, the thickness of the substrate gradually increases according to the inclination of the opening toward the outside of the membrane from the outer edge of the membrane.

In the substrate, the thicker the substrate, the larger the heat conduction amount, so that the heat conduction amount becomes smaller at a thin position near the outer edge of the membrane. Therefore, even if the heat conductive member is formed in the outer edge region of the membrane, if it is not formed in the inclined region of the opening, the heat conduction is performed through the thin portion of the substrate. If the formation position of the heat conductive member varies due to the variation in the workmanship of the membrane, the heat conductive member may or may not be formed in the inclined region of the opening between the upstream and downstream of the fluid flow. For this reason, the amount of heat conduction varies between the upstream and downstream of the fluid flow, and the influence of the variation in the workmanship of the membrane cannot be sufficiently suppressed. An object of the present disclosure is to provide the thermal flow rate sensor capable of suppressing variation in the amount of heat conduction between upstream and downstream of a fluid flow through the heater.

A thermal flow rate sensor according to one aspect of the present disclosure includes a substrate on which an opening having two opposite sides is formed, a thin film formed on the substrate, and a heat conductive member. The thin film forms a membrane, and between the two opposite sides, the membrane has a heater, an upstream temperature sensor located on one side of the heater, and a downstream temperature sensor located on the opposite side of the upstream temperature sensor across the heater. The heat conductive member promotes heat conduction from the heater to the substrate. In such a configuration, when an end of the opening on the membrane side is an upper end and an end on the side away from the membrane is a lower end, the heat conductive member covers from the upper end to the lower end of the opening in a normal direction of the membrane.

In this way, in the normal direction of the membrane, each heat conductive member is arranged so as to cover from the upper end to the lower end of the opening. Therefore, high thermal conductivity can be maintained by the heat conductive member even on the side surface of the opening whose thickness changes. Therefore, even if the workmanship of the membrane varies, its influence can be sufficiently suppressed. Therefore, it is possible to suppress the variation in the amount of heat conduction between the upstream and downstream of the fluid flow through the heater, reduce the variation in the responsiveness, and detect the flow rate of the fluid with high accuracy.

Hereinafter, embodiments of the present disclosure will be described with reference to the drawings. In each embodiment described below, same or equivalent parts are designated with the same reference numerals.

### First Embodiment

A first embodiment will be described. A thermal flow rate sensor according to the present embodiment is applied as, for example, an air flow sensor provided in an intake pipe of an engine in a vehicle, and is used for measuring an air flow rate for adjusting an intake air amount so that an air-fuel ratio is suitable for an operating state of the engine. Although not shown here, the airflow sensor includes a housing in which an air introduction pipe is formed, and is installed so that the air introduction pipe is exposed to the intake pipe of the engine. A part of the air flowing through the intake pipe is introduced into the air introduction pipe, and the air introduction pipe is branched in the housing, and the air flow sensor is installed on the branch path side, so that a main air flow is prevented from reaching the air flow sensor directly. Therefore, an influence of dust contained in the intake air is suppressed, and the amount of intake air can be detected accurately.

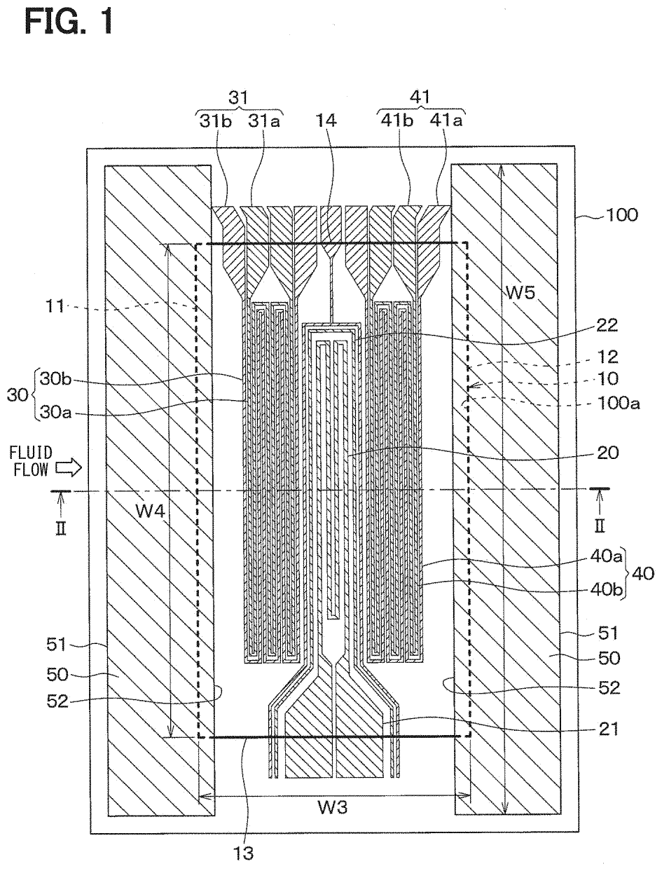

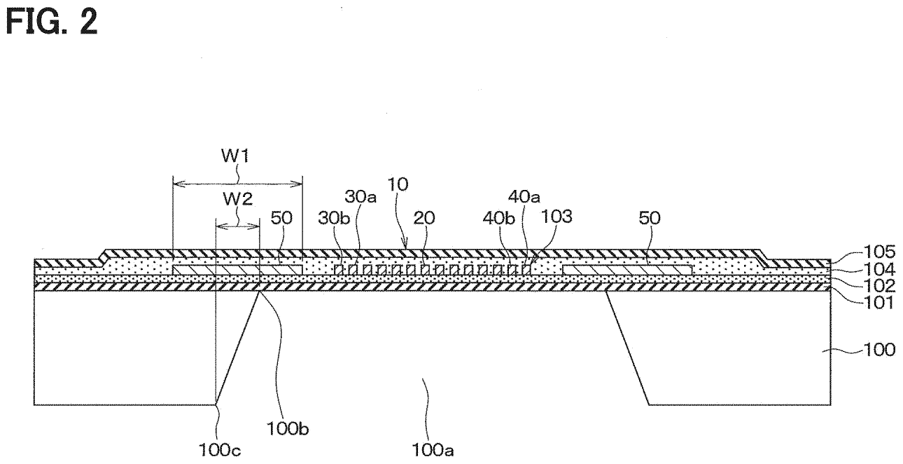

Hereinafter, the configuration of the thermal flow rate sensor of the present embodiment will be described with reference to FIGS. 1 and 2.

As shown in FIG. 1, the thermal flow rate sensor includes a heater 20, an upstream temperature sensor 30 located on an upstream side of an fluid flow of the heater 20, a downstream temperature sensor 40 located on a downstream side, a heat conductive member 50, and the like on the membrane 10. Further, although not shown, a control unit performs voltage application to each part of the thermal flow rate sensor, flow rate measurement of the fluid based on the detection signals of the upstream temperature sensor 30 and the downstream temperature sensor 40, and the like.

As shown in FIG. 2, a plurality of thin films 101 to 105 are formed on the substrate 100 made of silicon or the like, and an opening 100a is formed in the substrate 100, and the membrane 10 is composed of the thin films 101 to 105 at a portion formed as the opening 100a. The thin films 101 to 105 are a first silicon nitride film 101, a first silicon oxide film 102, a pattern layer 103, a second silicon oxide film 104, and a second silicon nitride film 105, and these films are laminated in this order. The pattern layer 103 is made of a resistor material, and constitutes the heater 20, the upstream temperature sensor 30, and the downstream temperature sensor 40. In the case of the present embodiment, the heat conductive member 50 is also composed of a part of the pattern layer 103. For example, although platinum (Pt) is used as the resistor material, other materials such as single crystal silicon, polycrystalline silicon, and molybdenum (Mo) can also be used. When the pattern layer 103 is made of single crystal silicon or polycrystalline silicon, impurities are doped in the portion where the current of the heater 20 flows, but the portion serving as the heat conductive member 50 may be non-doped.

Further, in the case of the present embodiment, a side surface of the opening 100a is in an inclined state. Hereinafter, an end of the opening 100a on the membrane 10 side is referred to as an upper end 100b, and an end on the side away from the membrane 10 is referred to as a lower end 100c.

As shown in FIG. 1, in the present embodiment, the membrane 10 has a rectangular shape composed of opposite sides 11 and 12 and two sides 13 and 14 different from the sides 11 and 12. Each side 11 to 14 of the membrane 10 does not actually appear on the surface side of the membrane 10, but a portion that can be confirmed by an optical microscope, an electron microscope, or the like is shown by a solid line, and a portion that cannot be confirmed by them is shown by a broken line. The heater 20, the upstream temperature sensor 30, and the downstream temperature sensor 40 are formed in the membrane 10. Although the heater 20, the upstream temperature sensor 30, the downstream temperature sensor 40, and the like are also shown in FIG. 2, they are shown in a simplified manner. Then, a pull-out wiring 21 of the heater 20, a pull-out wiring 31 of the upstream temperature sensor 30, and a pull-out wiring 41 of the downstream temperature sensor 40 are pulled out to the outside of the membrane 10.

The heater 20 is laid out in a meandering shape at a center position of the membrane 10 with a direction orthogonal to the fluid flow direction indicated by the arrow in the drawing (hereinafter, simply referred to as an orthogonal direction) as a longitudinal direction, and the pull-out wiring 21 is pulled out below a paper surface in FIG. 1. The heater 20 has a predetermined width to form a resistor, and generates heat when energized. An indirect heat type resistance temperature detector 22 is formed on the membrane 10 so as to surround the heater 20. Based on a change in the resistance value of the resistance temperature detector 22, the temperature of the heater 20 is measured in the control unit, and the amount of electricity supplied to the heater is feedback-controlled so that the temperature of the heater 20 becomes constant.

The upstream temperature sensor 30 is arranged on one side of the membrane 10 with the heater 20 as a center, that is, on the upstream side of the fluid flow. The upstream temperature sensor 30 is also laid out in a meandering shape with the orthogonal direction as the longitudinal direction. Further, the downstream temperature sensor 40 is arranged on the opposite side of the membrane 10 from the upstream temperature sensor 30 with the heater 20 as a center, that is, on the downstream side of the fluid flow. Therefore, the upstream temperature sensor 30, the heater 20, and the downstream temperature sensor 40 are arranged side by side with the fluid flow direction as the arrangement direction. The downstream temperature sensor 40 is also laid out in a meandering shape with the orthogonal direction as the longitudinal direction.

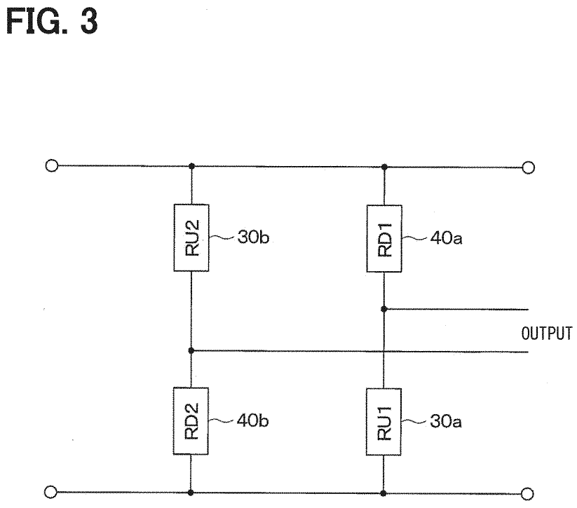

The upstream temperature sensor 30 and the downstream temperature sensor 40 may each be composed of one resistance temperature detector. However, in the case of the present embodiment, the upstream temperature sensor 30 and the downstream temperature sensor 40 form the Wheatstone bridge circuit shown in FIG. 3, and each of them is configured by two resistance temperature detectors so that a differential output can be obtained.

Specifically, the upstream temperature sensor 30 has a first resistance temperature detector 30a and a second resistance temperature detector 30b, and has a meandering shape so that the first resistance temperature detector 30a and the second resistance temperature detector 30b are arranged side by side. The pull-out wiring 31a and the pull-out wiring 31b are pulled out from each of them. In the Wheatstone bridge circuit shown in FIG. 3, the first resistance temperature detector 30a constitutes the resistance element RU1 and the second resistance temperature detector 30b constitutes the resistance element RU2.

Similarly, the downstream temperature sensor 40 has a first resistance temperature detector 40a and a second resistance temperature detector 40b, and is arranged in a meandering shape so that the first resistance temperature detector 40a and the second resistance temperature detector 40b are arranged side by side. The pull-out wiring 41a and the pull-out wiring 41b are pulled out from each of them. In the Wheatstone bridge circuit shown in FIG. 3, the first resistance temperature detector 40a constitutes the resistance element RD1 and the second resistance temperature detector 40b constitutes the resistance element RD2.

Then, in the Wheatstone bridge circuit of FIG. 3, a potential difference between a midpoint potential of the resistance element RU2 and the resistance element RD2 connected in series between a power supply line and a ground potential line and a midpoint potential of the resistance element RD1 and the resistance element RU1 connected in series between the power supply line and the ground potential line becomes a differential output. The potential difference is input to a control unit (not shown), and the control unit detects the flow rate of the fluid based on the differential output.

Although an outer part of the membrane 10 is omitted for each of the pull-out wiring 31a, 31b, 41a, and 41b, these pull-out wirings are appropriately connected so as to form the Wheatstone bridges of FIG. 3 with the resistance temperature detectors 30a, 30b, 40a, and 40b. The wiring width of each of the pull-out wirings 31a, 31b, 41a, and 41b is larger than that of the upstream temperature sensor 30 and the downstream temperature sensor 40.

Further, two heat conductive members 50 are provided along the two opposite sides 11 and 12 of the membrane 10, specifically, the two sides 11 and 12 which are opposed to each other in the fluid flow direction and extend in the orthogonal direction. The heat conductive member 50 is preferably made of a material having a higher thermal conductivity than that of the substrate 100, but may be made of a material having a thermal conductivity similar to that of the substrate 100 to assist the heat conduction of the substrate 100. In the case of the present embodiment, one heat conductive member 50 covers the entire side 11 and the other heat conductive member 50 covers the entire side 12. More specifically, as shown in FIG. 2, in the normal direction of the membrane 10, each heat conductive member 50 is arranged so as to overlap the entire side surface of the opening 100a from the upper end 100b to the lower end 100c. That is, in the normal direction of the membrane 10, the outer side 51 of each heat conductive member 50 is located outside the membrane 10 with respect to the lower end 100c, and the inner side 52 is located inside the membrane with respect to the upper end 100b.

For example, in the flow direction of the fluid, the width W1 of the heat conductive member 50 is set to several μm or more and several hundred μm or less, and the width W2 from the upper end 100b to the lower end 100c is set to be larger than 0 and several hundred μm or less. The width W1 needs to be larger than the width W2, and has a dimension that allows for a manufacturing error when forming the heat conductive member 50. The width W2 is determined by the angle (hereinafter referred to as the taper angle) of the side surface of the tapered opening 100a and the thickness of the substrate 100. Therefore, the width W1 is determined in consideration of the taper angle of the opening 100a, the thickness of the substrate 100, the width of the opening 100a, and the formation error of the heat conductive member 50.

In the membrane 10, the width W3 in the fluid flow direction and the width W4 in the orthogonal direction are both set to 300 μm to 700 μm. In FIG. 1, the width 3 is larger than the width W4 to make the membrane rectangular, but it may be square or the width W4 may be larger than the width W3. Further, in the case of the present embodiment, the width W5 of the heat conductive member 50 in the orthogonal direction is made larger than the width W4.

As described above, the thermal flow rate sensor of the present embodiment is configured. The thermal flow rate sensor configured in this way detects the flow rate of the fluid flowing in the direction of the arrow in FIG. 1. Specifically, the heater 20 is heated at a constant temperature based on energization from a control unit (not shown), and a constant voltage is applied from the power supply line of the Wheatstone bridge circuit.

At this time, when the fluid flows over the upstream temperature sensor 30 and the downstream temperature sensor 40, the temperature of the upstream temperature sensor 30 decreases and the temperature of the downstream temperature sensor 40 increases according to the flow rate. Then, the resistance values of the resistance temperature detectors 30a, 30b, 40a, and 40b constituting the upstream temperature sensor 30 and the downstream temperature sensor 40 change with the temperature change. For example, the resistance values of the first resistance temperature detector 30a and the second resistance temperature detector 30b constituting the upstream temperature sensor changes as shown in Equation 1, and the resistance values of the first resistance temperature detector 40a and the second resistance temperature detector 40b constituting the downstream temperature sensor 40 changes as shown in Equation 2. In Equations 1 and 2, R0 represents a resistance value at 0° C., a represents a temperature coefficient of resistance, and ΔT represents an amount of temperature change. When the resistance temperature detectors 30a, 30b, 40a, and 40b are made of metal, the resistance value increases as the temperature rises.

$$\begin{matrix}R = R 0 ( 1 - α Δ T ) & ( Equation 1 ) \\ R = R 0 ( 1 + α ΔT ) & ( Expression 2 )\end{matrix}$$

Therefore, the potential difference between the midpoint voltage of the resistance element RU2 and the resistance element RD2 and the midpoint voltage of the resistance element RD1 and the resistance element RU1 changes based on the temperature changes of the upstream temperature sensor 30 and the downstream temperature sensor 40 according to the flow rate of the fluid. The potential difference is input to the control unit from the Wheatstone bridge circuit as a differential output, and the control unit detects the flow rate of the fluid based on the differential output.

When performing such an operation, if the thermal conductivity from the heater 20 varies between the upstream temperature sensor 30 side and the downstream temperature sensor 40 side due to the variation in the workmanship of the membrane 10, it is impossible to detect the flow rate of the fluid accurately. That is, a responsiveness variation occurred between the upstream temperature sensor 30 and the downstream temperature sensor 40 in the upstream and downstream of the heater 20, in other words, a time constant of heat conduction varies, and the flow rate detection cannot be performed accurately. Further, a heat capacity varies between the upstream and downstream of the heater due to the variation in the workmanship of the membrane 10, and the responsiveness also varies due to the variation in the workmanship, so that more accurate flow rate detection cannot be performed. However, since the heat conductive member 50 is formed along the two opposite sides 11 and 12 of the membrane 10, heat conduction is promoted by the heat conductive member 50, and even if the workmanship of the membrane 10 varies, such the effect can be suppressed.

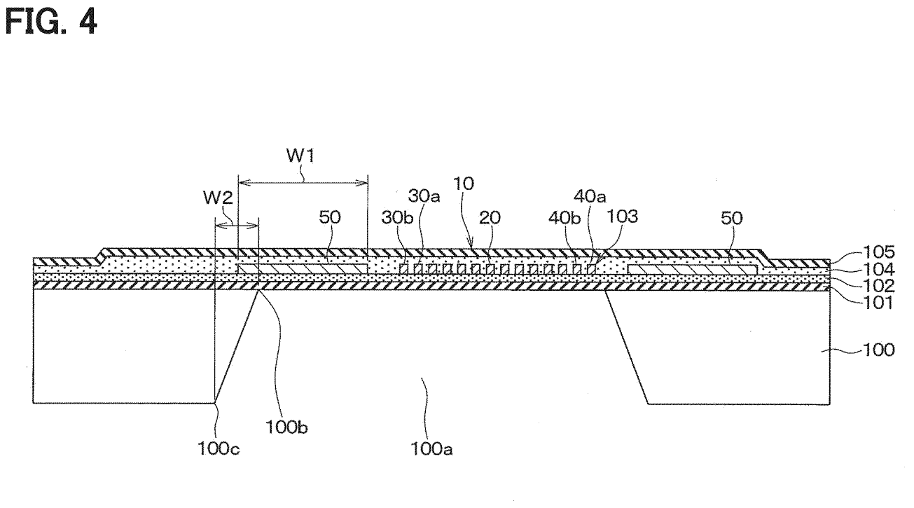

However, even if the heat conductive member 50 is formed on the outer edge of the membrane 10, as shown in FIG. 4, if there is a portion where the heat conductive member 50 is not formed in the inclined region of the opening 100a, heat conduction will be performed through a thin part of the substrate 100. In this configuration, if the formation position of the heat conductive member 50 varies due to the variation in the workmanship of the membrane 10, the heat conductive member 50 may or may not be formed in the inclined region of the opening 100a between the upstream and downstream of the fluid flow. For this reason, the amount of heat conduction varies between the upstream and downstream of the fluid flow, and the influence of the variation in the workmanship of the membrane 10 cannot be sufficiently suppressed.

On the other hand, in the thermal flow rate sensor of the present embodiment, each heat conductive member 50 is arranged so as to overlap the entire side surface of the opening 100a from the upper end 100b to the lower end 100c in the normal direction of the membrane 10. Therefore, high thermal conductivity can be maintained by the heat conductive member 50 even on the side surface of the opening 100a whose thickness changes. Therefore, even if the workmanship of the membrane 10 varies, its influence can be sufficiently suppressed. Therefore, it is possible to suppress the variation in the amount of heat conduction between the upstream and downstream of the fluid flow through the heater 20, and it is possible to detect the flow rate of the fluid with high accuracy.

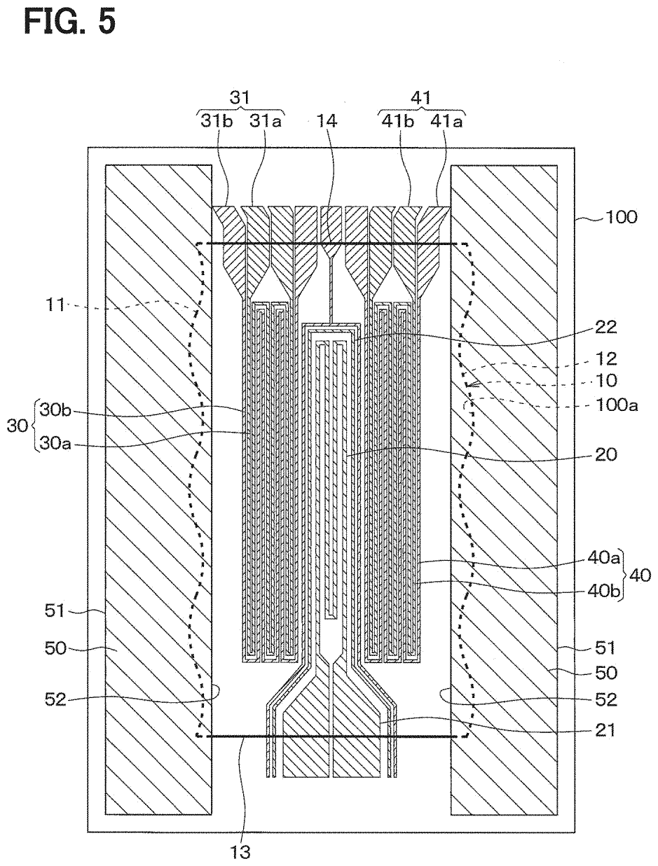

Further, as shown in FIG. 5, when the opening 100a is formed, the sides 11 and 12 do not become linear due to the etching variation, and the width W3 may vary in one product. In such a case, a portion of the sides 11 and 12 that is not covered by the heat conductive member 50 may occur, and the responsiveness may vary. Even in such a case, if the heat conductive member 50 is arranged so as to overlap the entire area of the sides 11 and 12, more specifically, the entire side surface of the opening 100a from the upper end 100b to the lower end 100c, the heat conduction can be controlled by the heat conductive member 50. Therefore, even if the width W3 varies due to the etching variation, the responsiveness variation can be suppressed.

Further, the thermal flow rate sensor configured as described above is formed as follows. First, the first silicon nitride film 101 and the first silicon oxide film 102 are formed on the substrate 100, and then a resistor material for forming the pattern layer 103 is formed. Then, a mask is placed on the resistor material to open the positions where the heater 20, the upstream temperature sensor 30, the downstream temperature sensor 40, the heat conductive member 50, etc. are to be formed, and the resistor material is etched to form the pattern layer 103. As a result, the heater 20, the upstream temperature sensor 30, the downstream temperature sensor 40, the heat conductive member 50, and the like are patterned. Further, the second silicon oxide film 104 and the second silicon nitride film 105 are formed in order so as to cover the pattern layer 103. Then, after arranging a mask on the back surface side of the substrate 100 at which the planned formation position of the opening 100a opens, the substrate 100 is etched by dry etching or the like to form the opening 100a. In this way, the thermal flow rate sensor is manufactured.

At this time, an error when forming the heat conductive member 50 may occur due to a mask shift when patterning the pattern layer 103 or a mask shift when forming the opening 100a. Further, there is a possibility that an error in forming the width W3 due to the variation in the lateral etching when the opening 100a is formed by etching may occur, and the side surface of the opening 100a may be tapered. However, the width W1 of the heat conductive member 50 is set in consideration of these formation errors, the taper angle of the side surface of the opening 100a, and the thickness of the substrate 100. Therefore, in the normal direction of the membrane 10, each heat conductive member 50 can be arranged so as to overlap the entire side surface of the opening 100a from the upper end 100b to the lower end 100c.

Then, if the heat conductive member 50 is formed together with the heater 20, the upstream temperature sensor 30, and the downstream temperature sensor 40 as a part of the pattern layer 103 as in the present embodiment, these components can be formed without misalignment. Therefore, the distance from the heater 20 to the heat conductive member 50 can be set without error, and it is possible to further suppress the variation in the amount of heat conduction between the upstream and downstream of the fluid flow through the heater 20.

(Modification of First Embodiment)

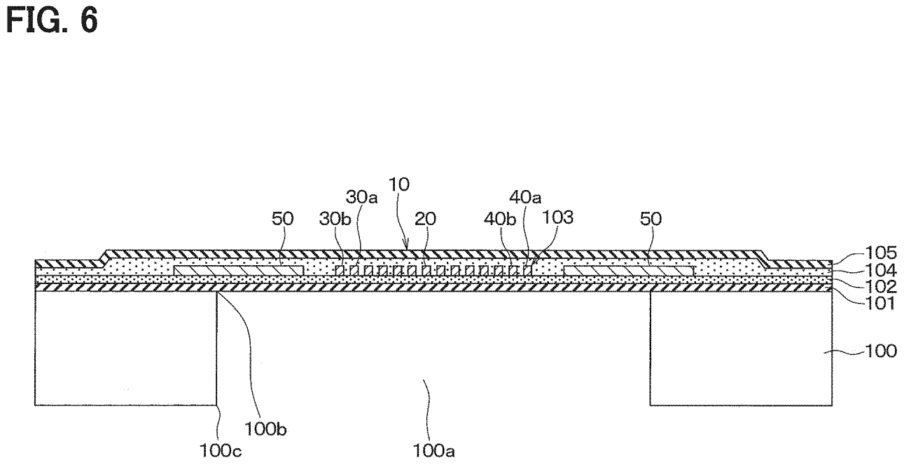

In the first embodiment, the case where the side surface of the opening 100a is tapered is described as an example. However, when the opening 100a is formed by dry etching, as shown in FIG. 6, the side surface of the opening 100a can be made substantially perpendicular to the surface of the substrate 100 due to high anisotropy. When the side surface of the opening 100a is perpendicular to the surface of the substrate 100 in this way, the width W2 can be set to 0.

Therefore, the width W1 of the heat conductive member 50 may be set in consideration with the formation error of the heat conductive member 50 due to the mask deviation when patterning the pattern layer 103 and the mask deviation when forming the opening 100a, and the formation error of the width W3.

Further, here, the heat conductive member 50 is configured as a part of the pattern layer 103 that constitutes the heater 20, the upstream temperature sensor 30, and the downstream temperature sensor 40. However, this configuration is only an example, and the heat conductive member 50 may be made of a material different from the pattern layer 103. For example, the pattern layer 103 may be made of Pt, and the heat conductive member 50 may be made of another material such as Mo.

Further, regardless of whether or not the heat conductive member 50 is formed as a part of the pattern layer 103, the thickness of the heat conductive member 50 is set to be different from that of the heater 20, the upstream temperature sensor 30, and the downstream temperature sensor 40. For example, it is preferable that the heat conductive member 50 is thicker than the heater 20, the upstream temperature sensor 30, and the downstream temperature sensor 40 because the amount of heat conduction can be increased. Such a configuration can be realized by, for example, forming the heat conductive member 50 as a part of the pattern layer 103, and further stacking the materials of the heat conductive member 50 by using a mask that opens only the part of the heat conductive member 50. Further, when the heat conductive member 50 is made of a material different from the pattern layer 103, the thickness of the material may be made thicker than that of the pattern layer 103 from the beginning.

### Second Embodiment

A second embodiment will be described. In the present embodiment, the layout of the heat conductive member 50 is changed with respect to the first embodiment, and the other parts are the same as those in the first embodiment. Therefore, the parts different from the first embodiment will be mainly described.

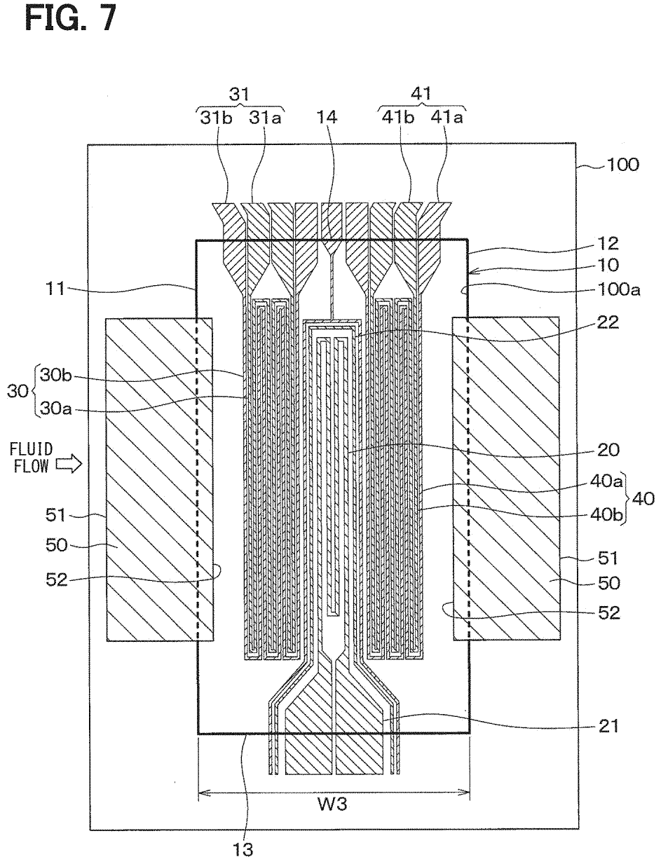

As shown in FIG. 7, also in the present embodiment, each heat conductive member 50 is arranged so as to cover the entire side surface from the upper end 100b to the lower end 100c of the opening 100a in the fluid flow direction. However, instead of covering the entire area of the sides 11 and 12, only the inner positions of the sides 11 and 12 are covered. That is, in the normal direction of the membrane 10, there is a portion where the sides 11 and 12 protrude from the heat conductive member 50. More specifically, each heat conductive member 50 is formed so that only the inner part separated from both ends of the sides 11 and 12 by a predetermined distance is covered. Therefore, in the normal direction of the membrane 10, the four corners of the membrane 10 composed of the sides 11 and 12 and the two sides 13 and 14 different from these sides 11 and 12 are not covered by the heat conductive member 50.

With such a configuration, when etching the opening 100a, the width W3 of the membrane 10 can be confirmed by transmitting from the upper surface side of the membrane 10 using an optical microscope, an electron microscope, or the like. For example, when the optical microscope is used, when light is irradiated from the substrate 100 side, the method of transmitting light differs between the membrane 10 and its surroundings, so that the width W3 can be confirmed based on this way.

Therefore, if the width W3 of the membrane 10 can be set to a desired value by controlling the etching conditions of the opening 100a, but the time constant of heat conduction does not reach the desired value, the etching amount can be adjusted by confirming the width W3. As a result, the time constant of heat conduction can be corrected to a desired value, and the flow rate of the fluid can be detected more accurately.

(Modification of Second Embodiment)

In the second embodiment, the heat conductive member 50 is arranged only at the inner part separated from both ends of the sides 11 and 12 of the membrane 10 by a predetermined distance. However, it is sufficient that at least a part of the sides 11 and 12 of the membrane 10 is not covered with the heat conductive member 50. For example, only two adjacent corners of the four corners of the membrane 10 in the fluid flow direction need not be covered with the heat conductive member 50. However, in the structure of the second embodiment, each heat conductive member 50 is axisymmetric with respect to the center line of the membrane 10 passing through the centers of the sides 11 and 12, and the heat conduction to the upstream temperature sensor and the downstream temperature sensor 40 can be made uniform.

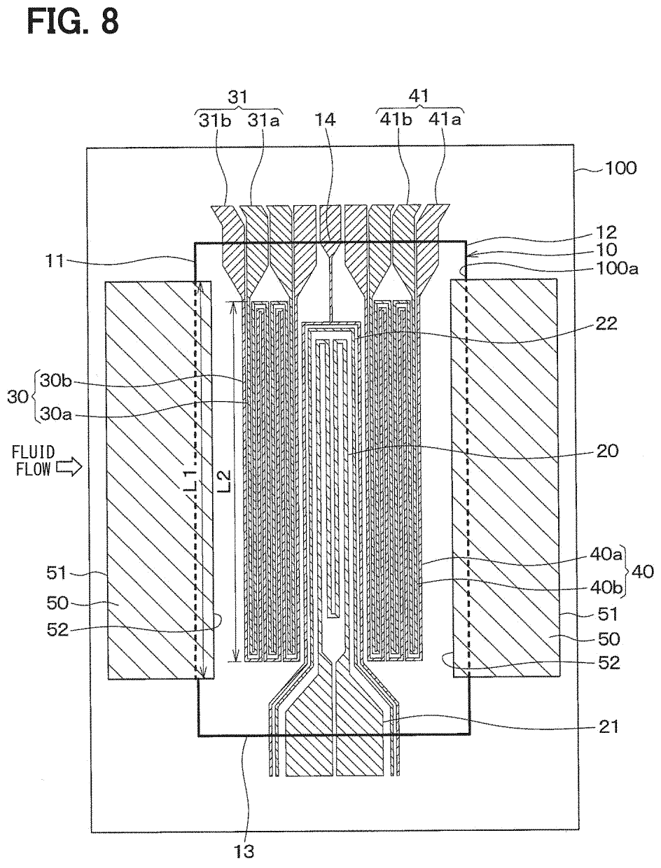

Here, the length of the heat conductive member 50 in the orthogonal direction is arbitrary, but as shown in FIG. 8, it is preferable that the length L1 of the heat conductive member 50 is set to be longer than the length L2 of the upstream temperature sensor 30 and the downstream temperature sensor 40 in the same direction. In the above configuration, it is possible to suppress the temperature change of each of the resistance temperature detectors 30a, 30b, 40a, and 40b, and it is possible to reduce the responsiveness variation of the upstream temperature sensor 30 and the downstream temperature sensor 40.

### Third Embodiment

A third embodiment will be described. In the present embodiment as well, as in the second embodiment, a part of the sides 11 and 12 of the membrane 10 can be confirmed, but the structure of the heat conductive member 50 for confirming the sides 11 and 12 is changed with respect to the second embodiment. Since the other configuration is the same as that of the first embodiment, only portions different from those of the first embodiment will be described.

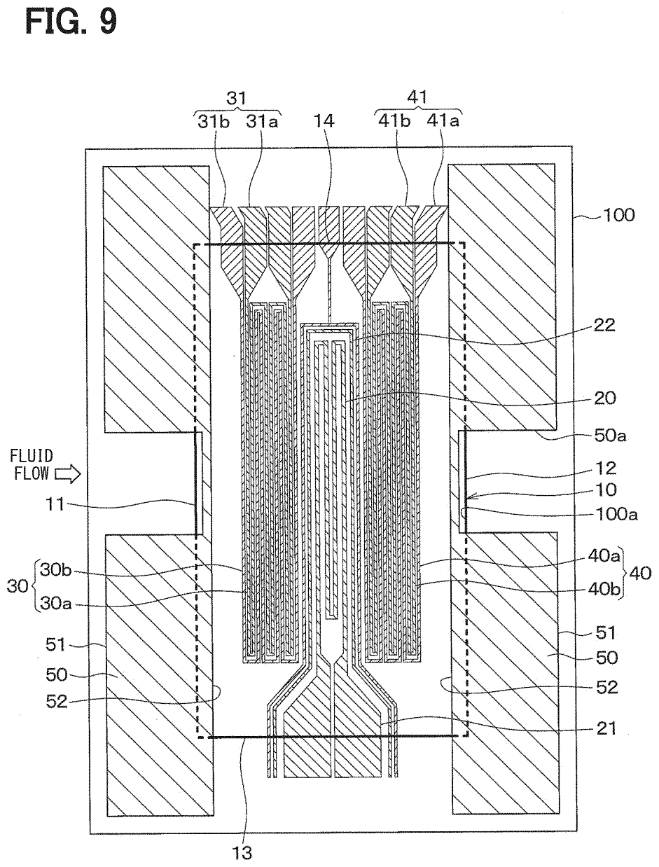

As shown in FIG. 9, in the present embodiment, a recess 50a is formed in a part of the heat conductive member 50 so that the sides 11 and 12 protrude from the heat conductive member 50 in the recess 50a so that the width W3 of the membrane 10 can be confirmed. In the present embodiment, regarding the recess 50a, a part of the heat conductive member 50 is recessed on the side opposite to the upstream temperature sensor 30 and the downstream temperature sensor 40. Therefore, on the side of the upstream temperature sensor 30 and the downstream temperature sensor 40, the heat conductive member 50 is linear, and the distance between the heat conductive member 50 and the upstream temperature sensor 30 or the downstream temperature sensor 40 is constant.

In this way, even if the recess 50a in which a part of the heat conductive member 50 is recessed is formed, the same effect as that of the second embodiment can be obtained. The recess 50a of the heat conductive member 50 may be formed so as to recess on the side of the upstream temperature sensor 30 and the downstream temperature sensor 40, and the above effect can be obtained. However, if the recess 50a of the heat conductive member 50 is formed on the opposite side of the upstream temperature sensor 30 and the downstream temperature sensor 40 as in the present embodiment, the side of the heat conductive member 50 on the side of the upstream temperature sensor 30 and the downstream temperature sensor 40 can be made linear. Therefore, it is possible to make the heat conduction uniform over the entire area in the orthogonal direction, and it is possible to measure the flow rate of the fluid more accurately.

The location of the recess 50a is arbitrary, but in the present embodiment, the recess 50a is formed at a center position of the membrane 10 in the orthogonal direction, that is, on the center line of the membrane 10. The portion located on the center line of the membrane 10 of the upstream temperature sensor 30 and the downstream temperature sensor 40 is a portion that particularly contributes to temperature measurement. Further, in this portion, the variation of the width W3 due to etching is most likely to occur. Therefore, by measuring the width W3 of the membrane 10 in this portion, the width W3 can be measured in the portion that further contributes to temperature measurement and in which the etching variation is reflected. This makes it possible to measure the flow rate of the fluid more accurately.

### Fourth Embodiment

A fourth embodiment will be described. In the present embodiment, the configuration of the heat conductive member 50 is changed from that of the first embodiment, and the remaining configurations are the same as those of the first embodiment, and therefore, only portions different from the first embodiment will be described.

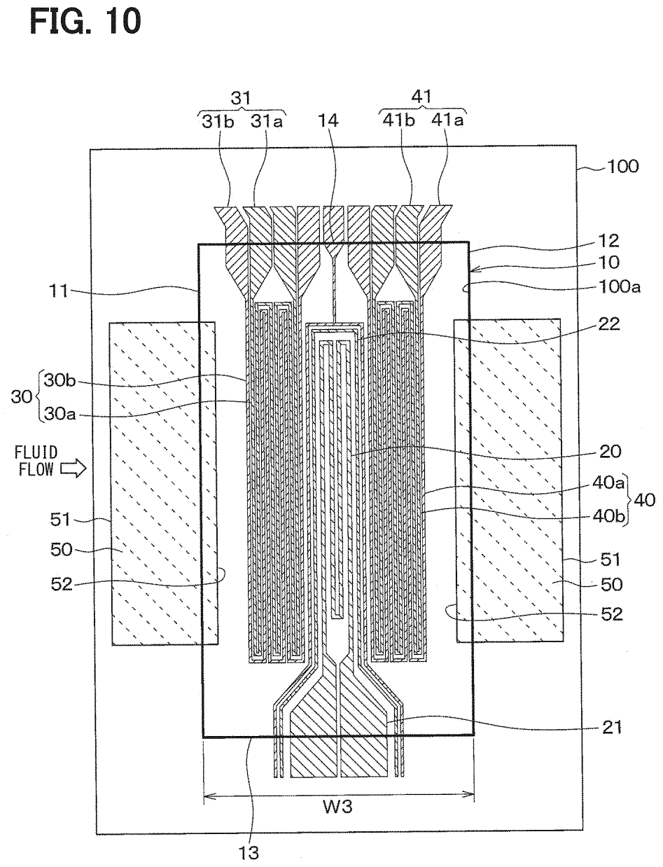

As shown in FIG. 10, in the thermal flow rate sensor of the present embodiment, the heat conductive member 50 is made of a permeable material so that the width W3 can be confirmed even from above the heat conductive member 50. The constituent material of the heat conductive member 50 may be selected according to the measuring method of the measuring device used when confirming the width W3. If an optical microscope is used, the heat conductive member 50 may be made of a translucent material, and if an electron microscope is used, the heat conductive member 50 may be made of a material that transmits an electron beam. Examples of the translucent material include ITO (Indium Tin Oxide).

As described above, even if the heat conductive member 50 is formed so as to cover the entire sides 11 and 12, if the heat conductive member 50 is made of the translucent material, the width W3 can be confirmed from above the heat conductive member 50. Even in this way, it is possible to obtain the same effect as that of the second embodiment.

### Fifth Embodiment

A fifth embodiment will be described. In the present embodiment, the configuration of the heat conductive member 50 is changed from that of the first to fourth embodiments, and the remaining configurations are the same as those of the first to fourth embodiments, and therefore, only portions different from the first to fourth embodiments will be described. Here, in the present embodiment, the case where the shape of the heat conductive member 50 is the one of the first embodiment will be described as an example, but the shape of the heat conductive members 50 of the second to fourth embodiments may be used.

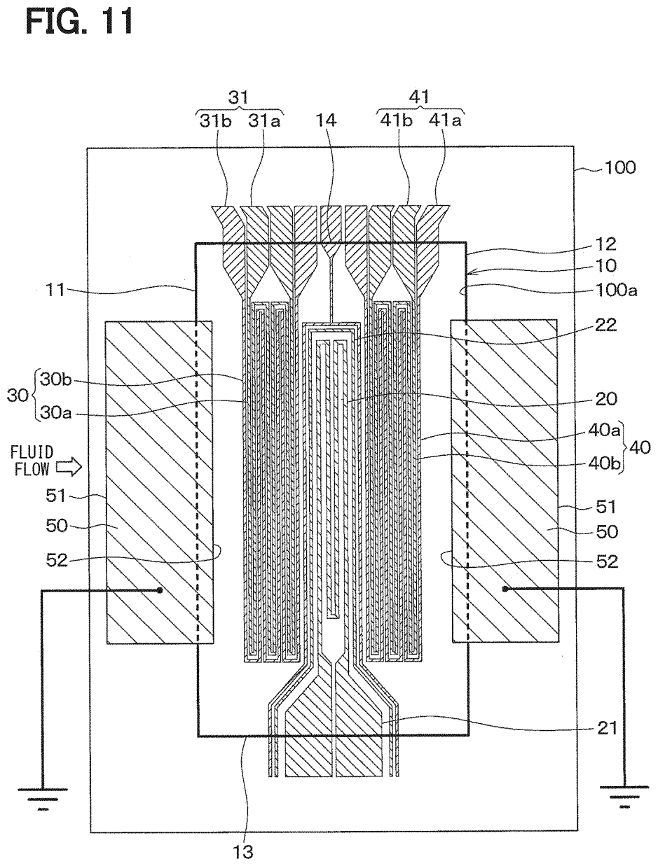

As shown in FIG. 11, in the present embodiment, the heat conductive member 50 is connected to a ground potential point to obtain the ground potential. When the heat conductive member 50 is set to the ground potential in this way, the effect of removing an electric charge of the dust when the dust in the fluid comes into contact with the heat conductive member 50 can be obtained. As a result, it is possible to suppress the adhesion of dust to the thermal flow rate sensor, particularly the membrane 10, and it is possible to measure the flow rate of the fluid more accurately.

### Other Embodiments

Although the present disclosure has been described in accordance with the above-described embodiments, the present disclosure is not limited to the above-described embodiments, and encompasses various modifications and variations within the scope of equivalents. In addition, while various combinations and configurations, which are preferred, other combinations and configurations including further only a single element, more or less, are also within the spirit and scope of the present disclosure.

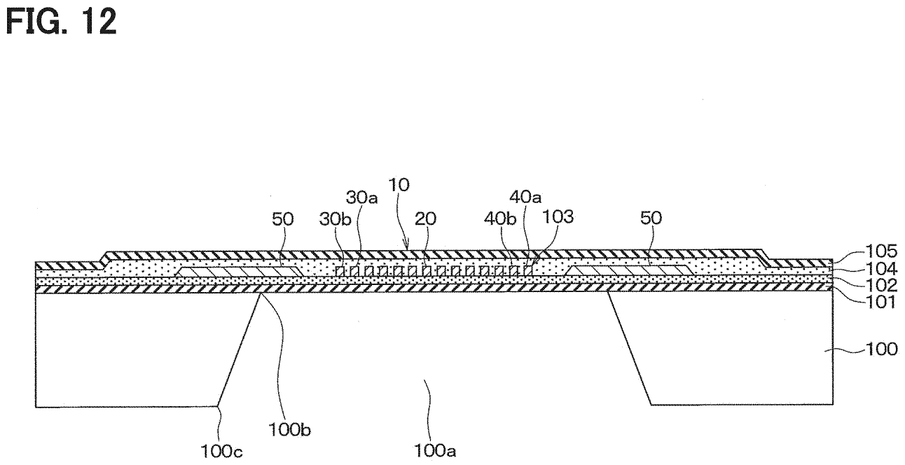

For example, FIG. 2 shows a structure in which the side surfaces are perpendicular to the upper surface and the lower surface of the heat conductive member 50, but as shown in FIG. 12, the side surface of the heat conductive member 50 is inclined from the upper surface to the lower surface. In the above configuration, it is possible to reduce the influence of an increase in the amount of heat conduction, such as an increase in power consumption due to the formation of the heat conduction member 50.

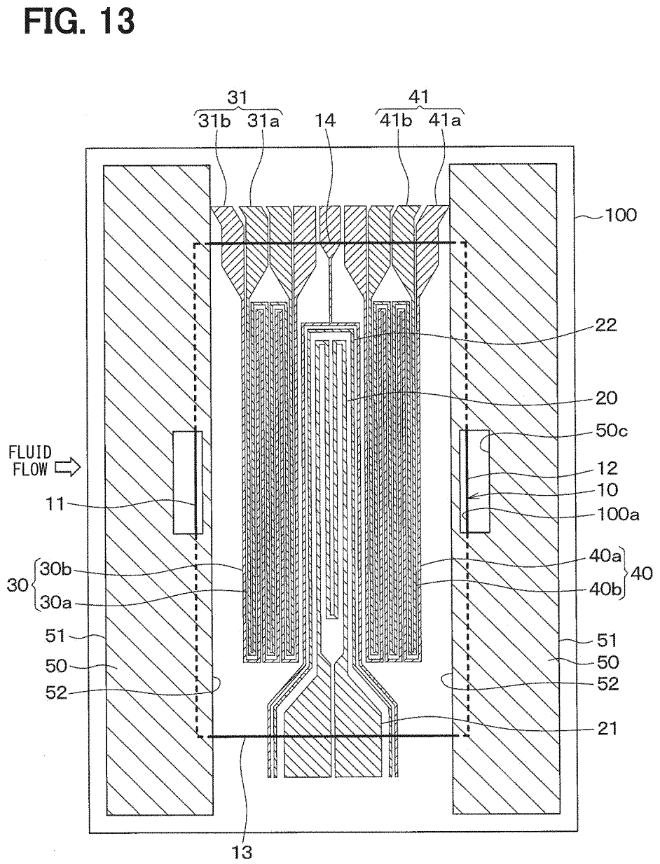

Further, in the second embodiment, the recess 50a is formed as the opening that allow the sides 11 and 12 to protrude from the heat conductive member 50 in order to confirm the width W3, but the opening has another shape. For example, as shown in FIG. 13, a window portion 50c having an opening inside the heat conductive member 50 may be formed as the opening so that the width W3 can be confirmed through the window portion 50c.

Further, in each of the above embodiments, an example is given in which the openings 100a forming the two opposite sides 11 and 12 have a quadrangular shape. However, this is also only an example, and the opening 100a may have another shape, for example, a polygonal shape. In that case, the upstream temperature sensor 30 and the downstream temperature sensor 40 interpose the heater 20 and they are arranged on both sides of the heater 20 between two opposite sides of the polygonal shape.

The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Furthermore, a shape, positional relationship or the like of a structural element, which is referred to in the embodiments described above, is not limited to such a shape, positional relationship or the like, unless it is specifically described or obviously necessary to be limited in principle.

What is claimed is:

1. A thermal flow rate sensor that detects a flow rate of a fluid, comprising:
a substrate formed with an opening having two opposite sides;
a thin film formed on the substrate, and having a membrane at a position corresponding to the opening, wherein the membrane includes a heater, an upstream temperature sensor arranged on one side with respect to the heater, and a downstream temperature sensor arranged on the opposite side of the upstream temperature sensor across the heater; and
a heat conductive member configured to cover the two sides and arranged on both sides of the heater, the upstream temperature sensor, and the downstream temperature sensor so as to promote heat conduction from the heater to the substrate, wherein
when an end of the opening on the membrane side is defined as an upper end and an end on the side away from the membrane is defined as an lower end, the heat conductive member covers from the upper end to the lower end of the opening in a normal direction of the membrane, and
a side of the heat conductive member facing the upstream temperature sensor is linear in an extending direction of the two sides, and a side of the heat conductive member facing the downstream temperature sensor is linear in the extending direction of the two sides.

2. A thermal flow rate sensor that detects a flow rate of a fluid, comprising:
a substrate formed with an opening having two opposite sides;
a thin film formed on the substrate, and having a membrane at a position corresponding to the opening, wherein the membrane includes a heater, an upstream temperature sensor arranged on one side with respect to the heater, and a downstream temperature sensor arranged on the opposite side of the upstream temperature sensor across the heater; and
a heat conductive member configured to cover the two sides and arranged on both sides of the heater, the upstream temperature sensor, and the downstream temperature sensor so as to promote heat conduction from the heater to the substrate, wherein
when an end of the opening on the membrane side is defined as an upper end and an end on the side away from the membrane is defined as a lower end, the heat conductive member covers from the upper end to the lower end of the opening in a normal direction of the membrane, and
the heat conductive member is made of a material different from that of the heater, the upstream temperature sensor, and the downstream temperature sensor.

3. A thermal flow rate sensor that detects a flow rate of a fluid, comprising:
a substrate formed with an opening having two opposite sides;
a thin film formed on the substrate, and having a membrane at a position corresponding to the opening, wherein the membrane includes a heater, an upstream temperature sensor arranged on one side with respect to the heater, and a downstream temperature sensor arranged on the opposite side of the upstream temperature sensor across the heater; and
a heat conductive member configures to cover the two sides and arranged on both sides of the heater, the upstream temperature sensor, and the downstream temperature sensor so as to promote heat conduction from the heater to the substrate, wherein
when an end of the opening on the membrane side is defined as an upper end and an end on the side away from the membrane is defined as a lower end, the heat conductive member covers from the upper end to the lower end of the opening in a normal direction of the membrane, and
the heat conductive member is connected to a ground potential point.

4. The thermal flow rate sensor according to claim 1, wherein
a side surface of the opening is perpendicular to a surface of the substrate.

5. The thermal flow rate sensor according to claim 1, wherein
at least a part of the two sides protrudes from the heat conductive member in the normal direction of the membrane.

6. The thermal flow rate sensor according to claim 5, wherein
the heat conductive member has openings that exposes at least a part of the two sides in the normal direction of the membrane.

7. The thermal flow rate sensor according to claim 1, wherein
the heat conductive member is made of a material that transmits the two sides in the normal direction of the membrane.

8. The thermal flow rate sensor according to claim 1, wherein
the heat conductive member is thicker than the heater, the upstream temperature sensor, and the downstream temperature sensor.

9. The thermal flow rate sensor according to claim 1, wherein
the heat conductive member is longer than the upstream temperature sensor and the downstream temperature sensor in an extending direction of the two sides.
